(19) United States
(12) Patent Application Publication
(10) Pub. No.: US 2022/0012506 A1
(43) Pub. Date: Jan. 13, 2022

(54) SYSTEM AND METHOD OF SEGMENTING FREE SPACE BASED ON ELECTROMAGNETIC WAVES

(71) Applicant: WISENSE TECHNOLOGIES LTD., Tel Aviv (IL)

(72) Inventors: Itai Orr, Or Akiva (IL); Moshe Cohen, Or Yehuda (IL)

(73) Assignee: WISENSE TECHNOLOGIES LTD., Tel Aviv (IL)

(21) Appl. No.: 16/926,955

(22) Filed: Jul. 13, 2020

(51) Int. Cl. G06K 9/00; G06K 9/62; G06T 7/12

(52) U.S. Cl. CPC G06K 9/00798; G06K 9/0063; G06T 2207/10036; G06T 7/12; G06K 2009/00644; G06K 9/6256

(57) ABSTRACT

A method and system for segmenting free space area, in real-time, based on data from an electromagnetic device may include: an image acquisition device adapted to capture an image of a scene; an electromagnetic device adapted to produce data corresponding to the scene; a non-transitory memory device, wherein modules of instruction code may be stored; and a processor, associated with the memory device, and configured to execute the modules of instruction code. Upon execution of said modules of instruction code, the processor may be configured to train a module to perceive elements in a scene.

### FIELD OF THE INVENTION

The present invention relates generally to analysis of signals received from a device that emits and receives electromagnetic (EM) energy. More specifically, the present invention relates to segmenting free space, in real-time, based on data from an EM-device such as a radar.

### BACKGROUND OF THE INVENTION

Machine-learning (ML) based methods and systems for controlling automated vehicles are known in the art. Currently available systems may include one or more sensors, adapted to obtain information pertaining to a vehicle's surroundings. An ML-based algorithm may be applied on that information, to produce decisions regarding navigation of the vehicle.

For example, currently available systems may employ a camera, adapted to produce a two dimensional (2D) image of a scene surrounding the vehicle, and an ML-based algorithm may be applied on the image, to identify (e.g., segment, as known in the art) objects (e.g., cars, pedestrians, etc.) that may appear in the scene, thus allowing the vehicle to navigate among the identified objects.

In another example, currently available systems may employ a radar unit, adapted to produce a three dimensional (3D) information describing a scene that surrounds the vehicle. The radar data may be clustered, and an ML module may be employed in order to identify regions of the clustered data, so as to produce an occupancy grid, allowing the vehicle to navigate within a drivable area.

### SUMMARY OF THE INVENTION

It may be appreciated by a person skilled in the art, that data originating from a radar unit may describe the surrounding of the vehicle in a noisy manner, that may be unintelligible (e.g., to a human observer). Automotive radars may normally produce sparse detections, in a raw level or a clustered level. The raw level is the richest form of the data but is also the nosiest. Therefore, currently available systems that include a radar unit may require a process of filtering or clustering the raw level radar data. For example, currently available systems may apply a noise filter on the radar signal such as a Constant False Alarm Rate (CFAR) filter, or a peak detection filter on the radar signal, resulting in a clustered level data, which is sparser than the raw level data, but is also less noisy.

Embodiments of the invention may apply a ML algorithm on a data elements representing signals from an EM device (EM-device), EM-unit or EM-system, e.g., a radar, in an unclustered or unfiltered form, and may thus provide a significant improvement over currently available systems in detection and/or segmentation of regions in an observed scene.

For example, it may be appreciated by persons skilled in the art that due to various physical aspects, the boundaries of drivable paths or roads may be notoriously difficult to detect. For example, due to the angle of reflection of RF energy from a road shoulder or a sidewalk's edge, the boundary of the drivable area may be difficult to discern from the surrounding noise. Embodiments of the invention may train an ML-based module, given an appropriate labeling data, to receive rich, unclustered EM-data, e.g., radar (or other EM-unit) data, and predict therefrom the edges of a drivable, free space or drivable area (e.g. space where a vehicle may be driven, such as a road without obstacles).

Embodiments of the present invention may include a method for segmenting a free space area from radar (or other EM-unit) data, in real-time. Embodiments of the method may include: obtaining labeled data produced based on a first scene captured by an image acquisition device; obtaining output from a radar or other EM unit produced with respect to the first scene; and training a neural network to identify elements related to maneuvering a vehicle using the labeled data and the output from the radar or EM-unit. An image acquisition device as referred to herein may be any device or system. For example, an image acquisition device may be an optical imaging device such as a camera or it may be a device that captures images based on infrared (IR) energy or waves emitted from objects or elements in a scene or an image acquisition device may be adapted to capture images (or otherwise sense presence) of objects or elements in a scene based on heat and the like. Accordingly, although for the sake of clarity a camera is mainly referred to herein it will be understood that any device capable of capturing images (or other representations) of elements in a scene may be used instead of a camera. Generally, any system that can provide a representation of elements in a scene where the representation can be labeled as described (e.g., to produce labeled data usable in training an ML-based model) may be used without departing from the scope of the invention.

According to some embodiments, the labeled data may reflect a distinction, difference between a drivable area (free-space) and other spaces in the first scene. Additionally, or alternatively, the labeled data reflects a distinction between a boundary of a drivable are (or free-space) and other elements in the first scene.

According to some embodiments, the labeled data may reflect or describe, for an origin point in the first scene, a direction and a distance to an object.

According to some embodiments, a field of view (FOV) of the image acquisition device may be aligned with an orientation of the radar or EM unit. For example, an image acquisition device (e.g., a camera) and an EM unit or radar may be installed or positioned such that their respective FOVs overlap and such that they both capture or sense at least one same element or object in a scene. In some embodiments, temporal calibration may be applied to output from an EM-device and output from an imaging device, e.g., temporally calibrating (or synchronizing) data (e.g., input signal or readings) from radar 20 and (or with) data (e.g., images) from image acquisition device 30 may include synchronizing these data items in time such that a reading from radar 20 is associated with an image which was taken when the reading was made.

For example, a set of time values (timestamps) pertaining to a set of images may be synchronized with a respective set of time values (timestamps) of readings received from the EM unit. For example, radar 20 and image acquisition device 30 may be installed, positioned or pointed such that their respective FOVs overlap, accordingly, one or more elements in a scene may be captured or sensed by radar 20 and by image acquisition device 30. In some embodiments, an overlap of FOVs may be identified or marked by calibration module 120.

Embodiments of the invention may include, providing data from an EM unit, produced with respect to at least one second scene to the neural network, and indicating, by the neural network, a drivable, free, space or area, and obstacles in the second scene.

Embodiments of the present invention may include a system for segmenting a free space area based on EM unit data (e.g. signals or readings), in real-time. Embodiments of the system may include: an image acquisition device adapted to capture an image of a scene; an EM (e.g., radar) unit adapted to produce an output corresponding to the scene; a non-transitory memory device, wherein modules of instruction code may be stored; and a processor, associated with the memory device, and configured to execute the modules of instruction code. Upon execution of said modules of instruction code, the processor may be configured to train a neural network (or an ML-based model or module as further described) to identify elements related to maneuvering a vehicle using the labeled data and the output from the EM unit or radar.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for segmenting free space based on data received from an EM unit (e.g. radar) according to some embodiments;

FIG. 2A is schematic diagram, depicting a top view example of a scene, surrounding a point-of-view, according to some embodiments;

FIG. 2B is schematic diagram, depicting a front view example of the same scene, according to some embodiments;

FIG. 3 is a block diagram, depicting an example of a system for segmenting free space based on signals received from an EM unit according to some embodiments of the invention;

FIG. 4 is a block diagram, depicting another example of a system for segmenting free space from radar data according to some embodiments of the invention;

FIG. 5 is a block diagram, depicting yet another example of a system for segmenting free space based on data from an EM unit according to some embodiments of the invention;

FIG. 6 is a block diagram, depicting an example of a system for segmenting free space based on EM unit data, during an inference stage, according to some embodiments of the invention; and

FIG. 7 is a flow diagram, depicting a method of segmenting free space based on data from an EM unit according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions that when executed cause a computer processor to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention disclose a method and a system for segmenting or identifying free space in an area based on, or from, a radar data (e.g., an input signal) generated from that area.

Although for the sake of clarity and simplicity a radar is mainly described and/or referred to herein, it will be understood that any suitable EM unit, system or device may be applicable and accordingly, the scope of the present invention is not limited by the type or nature of an EM device used. For example, any EM device, unit or system that includes an array of one or more antennas adapted to emit EM energy or waves and a unit adapted to sense or receive a reflection of the emitted EM energy or waves may be used by, or included in, embodiments of the invention. For example, a system according to some embodiments may include an antenna array and a transceiver adapted to emit EM waves and to receive EM waves. Generally, any device, unit or system that can, using EM energy or waves, identify or detect objects, or otherwise sense objects or elements in a space may be used. As further described, any EM device unit or system may be used by embodiments of the invention in order to segment, classify and/or sense specific elements, objects or spaces in a scene or in order to otherwise sense or understand a scene. The terms “radar”, “EM-unit”, “EM-device” and “EM-system” as used herein may mean the same thing and may be used interchangeably.

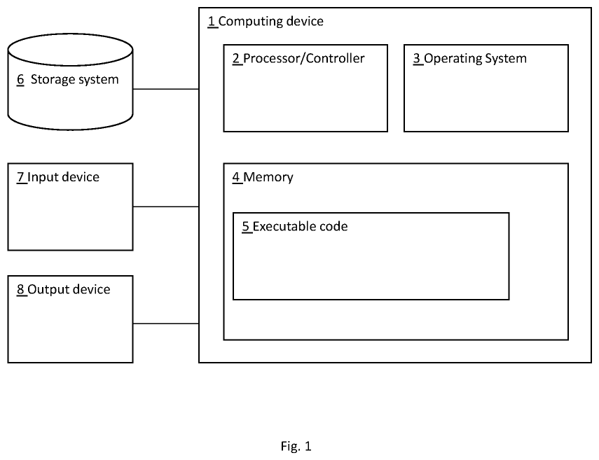

Reference is now made to FIG. 1, which is a block diagram depicting a computing device, which may be included within an embodiment of a system for segmenting free space from a radar data according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of, possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task or script. Executable code 5 may be executed by processor 2 possibly under control of operating system 3. For example, executable code 5 may be an application that may segment free space from, using, or based on, data received from a radar, as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to analysis of data received from a radar may be stored in storage system 6 and may be loaded from storage system 6 into memory 4 where it may be processed by processor 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to processor or controller 2), a plurality of input units, a plurality of output units, a plurality of memory units, and a plurality of storage units.

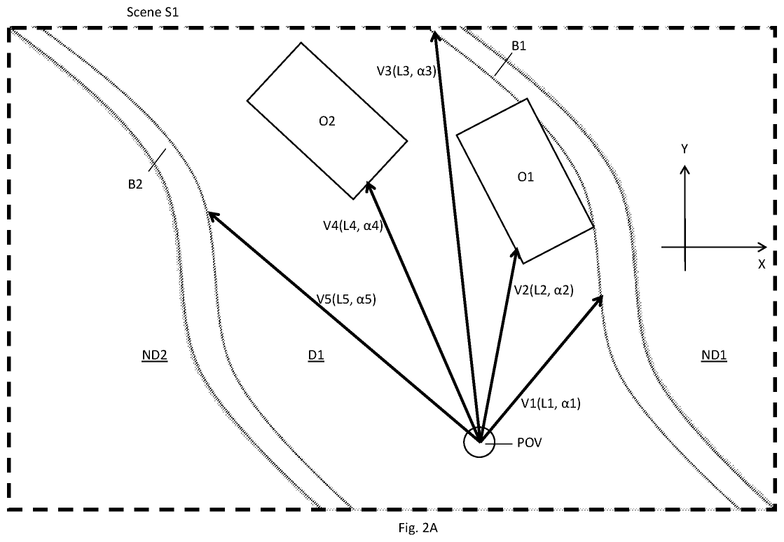

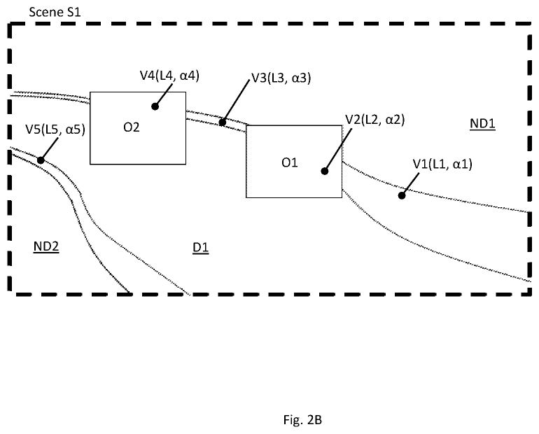

FIGS. 2A and 2B are schematic diagrams, depicting an example of a scene (e.g. a depiction of a real-world physical area), surrounding a point-of-view (marked POV), according to some embodiments. FIG. 2A depicts a top view of the scene S1, showing the relative distances and azimuth bearing from POV to elements in scene S1. FIG. 2A depicts a corresponding view of scene S1, as may be seen (e.g., by an observer) from POV.

As shown in both FIGS. 2A and 2B, scene S1 may include at least one free space, also referred herein as a drivable area (marked D1) and at least one occupied space, also referred to herein as a non-drivable area (marked ND1, ND2). In addition, scene S1 may include one or more borders, or border areas (marked B1, B2) that may define a limit or border between at least one drivable area (e.g., D1) and an adjacent at least one non-drivable area (e.g., ND1). In addition, scene S1 may or may not include one or more obstacles (e.g., marked herein as regions O1 and O2 within D1), such as cars, pedestrians, etc., that may or may not be included within the area defined by the one or more borders.

As shown in FIG. 2A and FIG. 2B embodiments of the invention may relate to predefined, arbitrary coordinates (marked herein as X and Y coordinates), defining a spatial relation of POV to each element (e.g., O1, O2, B1, B2, ND1, ND2, D1, etc.) in scene S1. Additionally, or alternatively, embodiments of the invention may relate to one or more locations in scene S1 by polar coordinates, centered at the location of POV. For example, embodiments may associate one or more locations in scene S1 with vectors (e.g., marked V1 through V5), each corresponding to a distance (marked by L1 through L5) and a respective azimuth (marked by α1 through α5).

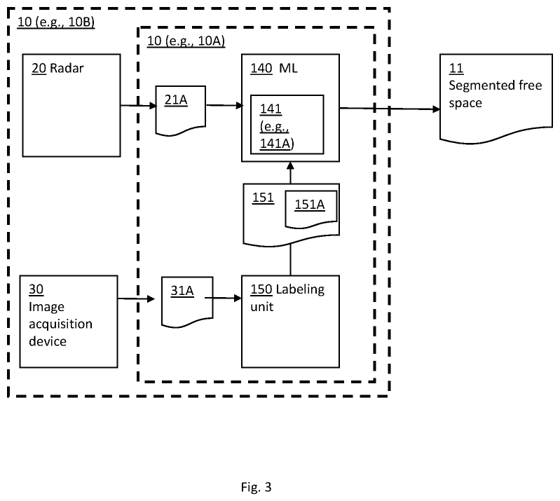

Reference is now made to FIG. 3, which depicts an example of a system 10 for segmenting free space from, or based on, data from a radar (e.g., input signal, image data) according to some embodiments of the invention. The term “segmenting” may refer, in this context, to a process of extracting, or indicating at least one portion or segment of radar data or input signal, as related to, or associated with, a drivable area or free space (e.g., element D1 of FIG. 2A and/or FIG. 2B) in a scene.

According to some embodiments of the invention, system 10 may be implemented as a software module, a hardware module or any combination thereof. For example, system 10 may be or may include a computing device such as element 1 of FIG. 1, and may be adapted to execute one or more modules of executable code (e.g., element 5 of FIG. 1) to identify or segment free space from, or based on, data from a radar, as further described herein.

According to some embodiments, system 10 (e.g., 10B) may include a radar unit 20, adapted to produce EM data (EM-data). For example, EM-data may be, or may include, at least one radar input signal or radar data element 21A, that may include information pertaining to a scene of radar 20's surroundings. System 10 may obtain EM-data, e.g., data element 21A, output from radar unit 20 that may be produced with respect to a 3D scene as elaborated herein (e.g., in relation to FIG. 2A).

Radar 20 may include one or more antennas, arranged in an antenna array (e.g., a 1-dimensional (1D) antenna array, 1D MIMO antenna array, a 2D antenna array, a 2D MIMO antenna array, and the like). The one or more antennas may be adapted to transmit radio frequency (RF) energy, and produce EM-data, e.g., a signal 21A pertaining to reflection of the RF energy from a target in a scene. An embodiment may process EM-data. For example, the one or more first data elements 21A may be digitized, sampled values, that may correspond to signals of the reflected RF energy. For example, EM-data such as radar data element 21A may include data pertaining to a plurality of vectors (e.g., V1 through V5), each including information regarding a distance (L) and azimuth (α) to a location in the 3D scene. As used herein, the term EM-data may relate to any data received from an EM-device, e.g., data elements 21A or any other input signal or reading from radar 20. As used herein, the term EM-data may relate to any data derived based on processing data, signal or reading from an EM-device, e.g., data elements 21B as further described herein.

One or more elements 21A or derivatives thereof may then be provided as one or more inputs to one or more modules, such as ML-based modules, that may be adapted as elaborated herein, to perform free space segmentation from the observed scene. A module as referred to herein, e.g., an ML-based module or NN module as described, may be a unit or a component that may include hardware, software and/or firmware, the terms module and unit may be used interchangeably herein.

Additionally, or alternatively, system 10 (e.g., 10A) may not include radar unit 20, but may instead be communicatively connected (e.g., via any type of appropriate, digital or analog communication) to radar 20, to receive EM-data, e.g., the one or more data signals 21A from radar unit 20.

According to some embodiments, system 10 (e.g., 10B) may include an image acquisition device (IAD) 30, such as an assembly of one or more cameras (typically cameras capturing visible light images, but other IADs capturing other types of images may be used), that may be adapted to produce at least one data element 31A, that may pertain to a 2D image of a scene. As used herein, the term image data may relate to any data received from an image acquisition device, e.g., image data may be, or may include, data elements 31A. As used herein, the term image data may relate to any data derived based on processing data received from an image acquisition device, e.g., image data may be, or may include, data elements 31B.

For example, IAD 30 may include a digital still camera, adapted to produce image data, e.g., a data element 31A, that is a cropped image of a predefined area of a scene, as depicted, for example, in FIG. 2B. In another example, IAD 30 may be or may include a video camera 30, and at least one image data element, e.g., data element 31A, may be a sampled image or frame of a video sequence captured by the video camera 30.

Additionally, or alternatively, system 10 (e.g., 10A) may not include IDA 30, but may instead be communicatively connected (e.g., via any type of appropriate, digital or analog communication) to IDA 30, to receive the one or more data elements 31A from IDA 30.

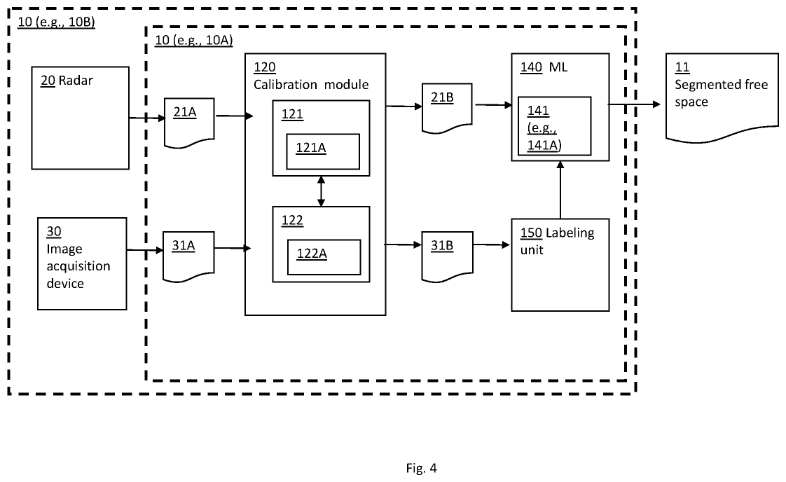

According to some embodiments, and as elaborated herein (e.g., in relation to FIG. 4), EM-data, e.g., the data of data element 21A and of an image data element (e.g., data element 31A) may be calibrated, so as to relate to or describe the same observed scene, at the same time. For example, as shown in the schematic examples of FIG. 2A and FIG. 2B, EM-data and image data may be spatially calibrated. For example, data in data element 21A (e.g., as depicted in FIG. 2A) and data element 31A (e.g., as depicted in FIG. 2B) may be spatially calibrated, in a sense that they may portray the same field of view (FOV) of scene S1. Additionally, 21A and 31A may be temporally calibrated, or synchronized, in a sense that they may produce a portrayal of scene S1 at substantially the same time. Accordingly, an embodiment may spatially calibrate elements captured by radar 20 with elements captured by the image acquisition device 30.

As shown in FIG. 3, system 10 may include a labeling unit 150, adapted to produce labeled data 151, based on (e.g. describing) a scene (e.g., S1) captured by IDA 30. Labeled data may be any data and/or metadata produced based on a scene as captured by an image acquisition device, e.g., labeled data 151 may be produced based on an image captured and/or produced by image acquisition device 30 with respect to scene S1. For example, labeled data 151 may reflect or describe a distinction between drivable areas or spaces (or free-space, e.g., D1) and other spaces (e.g., ND1, ND2) in scene S1. Additionally, or alternatively, labeled data 151 may reflect or describe a distinction or the difference between a boundary (e.g., B1) of a drivable, free-space (e.g., separating D1 and ND1) and other elements (e.g., D1, ND1, ND2) in scene S1. Labeled data 151 (or a label 151A) may be, or may include, any metadata related to image data. For example, label 151A or labeled data 151 may include measurements (e.g., indication of distances between points or elements in a scene, directions and the like); processed measurements; estimations; semantic information describing elements or attributes of elements in a scene; or a 2D or 3D map generated based on image data.

For example, in a condition that data element 31A is an image (e.g., as depicted in FIG. 2B), the term label may refer in this context to an association of at least one area in scene S1 (e.g., an area of image 31A) with a value (e.g., a numeric value) that may identify or describe that area as pertaining to a specific area type (e.g., drivable area, free space, etc.).

According to some embodiments, labeling unit 150 may be or may include a computing device (e.g., element 1 of FIG. 1), that may be configured to obtain, (e.g., from a user of from a software application, via input device 7 of FIG. 1) a label of at least one drivable area (also referred herein as a free space, e.g., D1), and/or non-drivable area (e.g., ND1, ND2). For example, labeling unit 150 may present 31A to a human user, as an image on a screen (e.g., output device 8 of FIG. 1), and may allow the human user to label at least one area as drivable (e.g., D1) or non-drivable (e.g., ND1).

According to some embodiments, labeling may be a semi-automated process, for example, a system may identify elements in an image (e.g., a boundary of a drivable are, free space etc.) and may suggest to a user to mark the elements, accordingly, in some embodiments, labeling may be a semi-automated process where a system automatically identifies elements yet a user can manually label elements or approve suggested labeling.

[symbol] and an automated process. According to some embodiments, labeling may a fully automated process where by a system automatically identifies elements in a scene based on image data and automatically labels the elements, e.g., by adding or associating labels to elements in an image as described.

Additionally, or alternatively, labeling unit 150 may be or may include an ML-based module configured to, or pre-trained to perform an image analysis task, to produce said labeled information 151 automatically. For example, labeling unit 150 may be adapted to receive data element 31A as an image, and produce therefrom labeled data element 151, that is an annotated or labeled image (e.g. including labels or annotations describing elements within an image), and that may include at least one label 151A of a free space area (e.g., D1) and/or a label 151A of a non-drivable area (e.g., ND1, ND2) and/or a label 151A of an object (e.g., O1, O2).

A neural network (NN), e.g. a neural network implementing a machine learning model, may refer herein to an information processing paradigm that may include nodes, referred to as neurons, organized into layers, with links between the neurons. The links may transfer signals between neurons and may be associated with weights. A NN unit, component or module may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor unit (e.g., element 2 of FIG. 1) such as one or more CPUs or graphics processing units (GPUs), or a dedicated hardware device may perform the relevant calculations and thus may act as a NN, and may execute (e.g. infer) or train a NN model, and may act as an ML-based module.

According to some embodiments, system 10 may include at least one ML-based module 140 that may be or may include one or more NN models 141. During a training stage embodiments of the invention may train a NN model 141 to identify elements related to maneuvering a vehicle, using the output data element 21A from the radar unit as input, and using labels 151A of labeled data 151 as supervisory input.

For example, ML module 14 may identify elements related to maneuvering a vehicle by producing a segmentation of free space 11 from data element 21 of radar 20. In such embodiments, segmented free space 11 may include labeled data, that may reflect or describe, for an origin point in the first scene, a direction and a distance to at least one element or object in the scene. For example, the labeled data may associate a direction and/or a distance from the vehicle (e.g., from POV) to at least one element (e.g., object O1, O2, drivable area D1, non-drivable area ND1, ND2) in scene S1, with a respective annotation or label 151A (e.g., O1, O2, D1, ND1 and ND2 respectively).

An element may be a delimiter or boundary of a drivable area, or a free area or space. For example, labeled data in segmented free space 11 may include, reflect or describe, for an origin point in the first scene, a direction and a distance to a delimiter of a drivable area, e.g., from the POV shown in FIG. 2A to border, boundary or delimiter B1 as illustrated by vectors V1 and V3 in FIG. 2A.

Segmented free space 11 may subsequently be presented by a computing device (e.g., element 1 of FIG. 1) as an image on a screen (e.g., a radar image on a radar screen, such as output element 8 of FIG. 1).

Reference is now made to FIG. 4, which depicts another example of a system 10 for segmenting free space from a radar input signal (EM-data) according to some embodiments of the invention. As shown in FIG. 4, system 10 may include a calibration module 120, adapted to calibrate data elements 21A and/or data elements 31A, so as to produce data elements 21B and 31B respectively.

According to some embodiments, calibration module 120 may include a spatial calibration module 121, adapted to spatially calibrate data elements 21A and data elements 31A, in a sense that respective, calibrated data elements 21B and 31B may portray the same FOV of scene S1. In other words, the FOV (e.g., orientation, viewing angle) of scene S1, as portrayed by data element 31B of IAD 30 may be aligned (e.g. correspond completely or substantially with, or overlap at least in part with) with the FOV of scene S1, as portrayed by data element 21B of radar 20.

Additionally, calibration module 120 may include a temporal calibration module 122, adapted to synchronize (e.g., using a data buffer), or temporally calibrate, synchronize or match data elements 21A and data elements 31A, in a sense that respective, calibrated or synchronized data elements 21B and 31B may portray scene S1 as sampled at substantially the same time.

For example, calibrated data elements 31B may include a first set of time values 122A (e.g., timestamps) corresponding to a set of images, and calibrated data elements 21B may include a second set of time values 121A (e.g., timestamps) of readings received from radar 20. Calibration module 120 may emit data elements 21B and 31B such that timestamps 121A and 122A may be respectively synchronized.

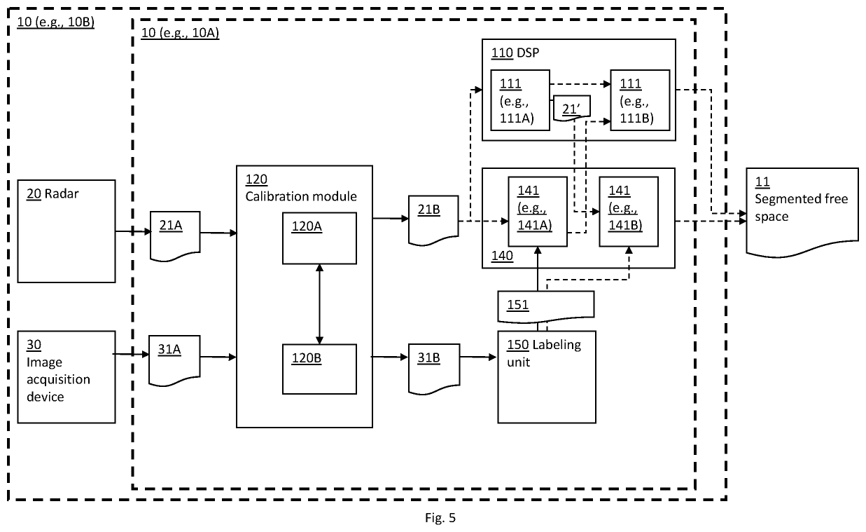

Reference is now made to FIG. 5, which depicts yet another example of a system 10 for segmenting free space from a radar input signal (or other EM-data) according to some embodiments of the invention. According to some embodiments, system 10 may include a digital signal processing (DSP) module 110, configured to receive calibrated data element 21B, and may be adapted to apply one or more operations of signal processing on data element 21B as part of the process of producing segmented free space data element 11.

According to some embodiments, DSP module 110 may have or may include one or more processing modules 111, (e.g., 111A, 111B, etc.) adapted to receive signal 21A (or 21B), apply at least one signal processing operation as known in the art, to produce processed signal 21′.

For example, processing modules 111 may include a sampling (e.g., an up-sampling) module, configured to sample received signal 21A (or 21B) and/or an analog to digital (A2D) conversion module, in an implementation where 21A (or 21B) is an analog signal.

In another example, processing modules 111 may include a gain module (e.g., an analog gain module, a digital gain module, etc.), configured to control a gain of signal 21A (or 21B).

In another example, processing modules 111 may include for example, a thresholding module, configured to modify signal 21A (or 21B) according to a predefined or adaptive threshold, one or more filtering modules (e.g., an adaptive band-pass filter, a clutter filter and the like), configured to filter sampled signal 21A (or 21B), a range ambiguity resolution module, as known in the art, and/or a frequency ambiguity resolution module, as known in the art.

Processing modules 111 may be included in DSP module 110 according to the specific implementation of radar 20 as known in the art, as part of the process of creating segmented free space data element 11. In such embodiments, ML module 140 may include one or more supervised ML models 141 (e.g., 141A, 141B), where each of the one or more ML models 141 may be configured to receive one or more first data elements (e.g., EM-data 21A, 21B, 21′) originating from radar 20 as input, and one or more labeled data elements 151 originating from IAD 30.

Embodiments of the present invention may train the at least one supervised ML models 141 to generate segmented free space data element 11 based on the one or more first data elements (e.g., 21A, 21B, 21′). The one or more first data elements 21′ (e.g., 21A′) may be used or may serve as a training data set; and the one or more second data elements 151 may be used or may serve as supervising annotated data or labeled data for training the at least one ML model 141 (e.g., 141A, 141B).

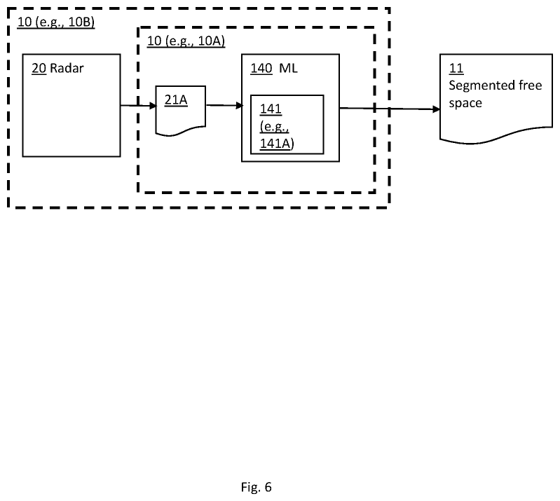

Reference is now made to FIG. 6, which is a block diagram, depicting an example of a system for segmenting free space from EM-data such as radar input signal, during an inference stage, according to some embodiments of the invention. As known in the art, ML-based systems may require a first stage of training (and/or verification, as known in the art), where the ML model may be trained against a training data set, and a second stage of inference, in which the trained ML model is applied on new, acquired data to produce output.

It may be appreciated by a person skilled in the art that as FIGS. 3, 4 and 5 may depict system 10 in a training (or verification) stage, FIG. 6 may depict system 10 in an inference stage. In such embodiments, system 10 may be deployed in a large number of instances (e.g., in thousands of vehicles), and may employ trained model 141 (e.g., 141A) to produce a segmented drivable area 11 from data element 21A, originating from radar 20. For example, as described, using labeled data, an ML-based module may be produced (e.g., ML-based module 141 in FIG. 6) where the ML-based module is adapted (e.g. configured or trained) to perceive, or understand, which elements exist in a scene and further configured, adapted or trained to perceive or understand the nature or type of elements and/or relations between elements in the scene. For example, ML-based module 141 may be adapted, configured or trained, to identify, perceive or understand where, in a scene, a drivable space exists (e.g., identify, perceive or understand the space occupied by D1 in FIG. 2A). In another example and as described, an ML-based module 141 may be adapted, configured or trained, to identify, perceive or understand a boundary, border, edge or other separator between drivable space and non-drivable space (e.g., identify or perceive boundaries B1 and B2 are in FIG. 2A or understand where these boundaries are in a scene).

In other words, as shown in FIG. 6, embodiments may provide EM-data (e.g., input 21A) from radar 20, that is produced with respect to a second scene (e.g., not included in a training data set) to neural network model 141. Neural network model 141 may subsequently produce (e.g. at inference time) data element 11 that may indicate at least one of: (a) a drivable free-space (e.g., element D1 of FIG. 2A) segment in the second scene; (b) objects and/or obstacles (e.g., elements O1, O2 of FIG. 2A) segments in the second scene; and (c) a non-drivable (e.g., elements ND1, ND2 of FIG. 2A) segments in the second scene.

According to some embodiments, segmented free space data element 11 may subsequently be used to produce at least one suggestion for operating (e.g., steering, braking or accelerating) a (e.g., automated or autonomous) vehicle. For example, segmented free space data element 11 may be used as input to a controller (e.g., element 2 of FIG. 1), adapted to control a steering mechanism of an automated vehicle, and controller 2 may use segmented free space data element 11 to plan a course for driving the automated vehicle, while remaining in the drivable area D1. It will be noted that embodiments of the invention may be used for operating an autonomous vehicle or embodiments of the invention may be used for aiding a human driver. For example, having identified or perceived elements in a scene as described, an embodiment may provide suggestions or warnings to a human driver, e.g., “slow down”, “bear left” and so on.

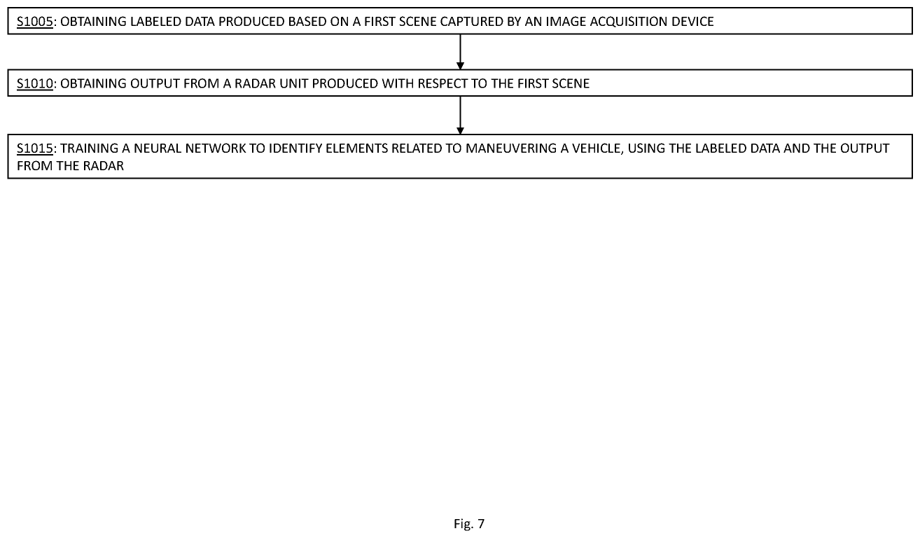

Reference is now made to FIG. 7, which is a flow diagram, depicting an example of a method of segmenting free space from EM-data (e.g., radar input signals), by at least on processor (e.g., element 2 of FIG. 1), according to some embodiments of the invention.

As shown in step S1005, processor 2 may obtain labeled data (e.g., element 151 of FIG. 3), produced based on a first scene (e.g., element S1 of FIGS. 2A and/or 2B), captured by an image acquisition device (e.g., element 30 of FIG. 3), such as a camera.

As shown in step S1010, processor 2 may obtain output or data (e.g., element 21A of FIG. 3) from a radar unit (e.g., element 20 of FIG. 3), produced with respect to the first scene S1.

As shown in step S1010, processor 2 may train a neural network (e.g., NN model 141 of FIG. 3) to identify elements (e.g., elements O1, O2, D1, ND1 and ND2 of FIG. 2A) related to maneuvering a vehicle using the labeled data 151 and the output 21A from the radar.

Embodiments of the invention improve the fields of self-driving, autonomous, or driverless vehicles as well as computer aided driving. For example, some known systems require substantial processing of radar readings before the readings can be used, however, such processing is costly in terms of costs of required components (e.g., a large memory and a powerful processor) as well as with respect to efficiency and response time of a system. Embodiments of the invention improve the fields of autonomous vehicles and computer aided driving by enabling using substantially unprocessed data received from a radar or other EM-device. For example, an ML-based module as described may be trained to identify elements in a scene based on substantially raw, unprocessed data or readings received from a radar, accordingly the response time of a system may be improved and, at the same time, cost and complexity of the system may be reduced.

Another drawback of known systems is related to accuracy. For example, in order to eliminate noise from radar readings, some known systems use filters, however, small objects or contours, e.g., curbs, sidewalks and/or small obstacles are typically lost or removed by a filter thus preventing such systems from identifying small elements which may be of great importance with respect to operating and/or maneuvering a vehicle.

As described, in some embodiments, an ML-based module may be trained to perceive elements of any size in a scene, accordingly, embodiments of the invention may identify objects or elements of any (possibly very small) size. For example, elements such as a sidewalk, a stone on the road or a small/low fence marking a side of a road may be lost or removed by filtering applied by prior art systems and methods, however, such small elements may be readily identified, sensed or perceived by a trained ML-based module as described.

Some known systems use peak detection to identify peaks (e.g. local maxima) in radar readings, however, such approach leads, in some cases, to identifying (and marking or taking into account) small and insignificant objects, for example, peak detection may cause a prior art system to maneuver a vehicle around a small, insignificant stone on a road because the stone may be peak detected. By training ML-based module as described, embodiments of the invention enable ignoring insignificant (e.g., very small) objects and, at the same time, eliminate the need of applying peak detection, thus further improving the field of automated operation of vehicles and/or the technological field of detecting elements which are relevant to maneuvering or operating a vehicle.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method comprising:
obtaining image data captured by an image acquisition device;
obtaining EM data captured by an electromagnetic device (EM device); and
training a module to perceive elements using the EM data and a label, wherein the label is produced based on the image data.

2. The method of claim 1, wherein the label reflects a distinction between a drivable area and other spaces in a scene.

3. The method of claim 1, wherein the label reflects a distinction between a boundary or delimiter of a drivable, free-space and other spaces in a scene.

4. The method of claim 1, wherein the label reflects, for an origin point in a scene, a direction and a distance to a delimiter of a drivable, free-space.

5. The method of claim 1, wherein a field of view of the image acquisition device overlaps a field of view of the EM device.

6. The method of claim 1, comprising spatially calibrating the EM device with the image acquisition device.

7. The method of claim 1, comprising temporally synchronizing the EM data with the image data.

8. The method of claim 1, comprising providing EM data to the module and indicating, by the module, a drivable, free-space and obstacles in a scene.

9. The method of claim 1, comprising providing EM data to the module and producing, by the module, at least one suggestion for operating a vehicle.

10. The method of claim 1, wherein the label is produced by one or more of: a human, a semi-automated process and an automated process.

11. A system comprising:
an image acquisition device adapted to produce image data;
an EM device adapted to produce EM data;
a non-transitory memory device, wherein modules of instruction code are stored; and
a processor, associated with the memory device, and configured to execute the modules of instruction code,
wherein upon execution of said modules of instruction code, the processor is configured to train a module to perceive elements using the EM data and a label,
wherein the label is produced based on the image data.

12. A system comprising:
an electromagnetic device (EM device) adapted to produce EM data; and
a module adapted to perceive elements based on the EM data;
wherein the module is produced by:
obtaining image data captured by an image acquisition device;
obtaining EM data captured by an EM device; and
training the module to perceive elements using the EM data and a label,
wherein the label is produced based on the image data.

13. The system of claim 13, wherein the label reflects a distinction between drivable area and other spaces in a scene.

14. The system of claim 13, wherein the label reflects a distinction between a boundary or delimiter of a drivable area and other elements in a scene.

15. The system of claim 13, wherein the label reflects, for an origin point in a scene, a direction and a distance to a delimiter of a drivable area.

16. The system of claim 12, wherein a field of view of the image acquisition device overlaps a field of view of the EM device.

17. The system of claim 12, comprising, temporally calibrating the EM data with the image data.

18. The system of claim 13, wherein the module indicates a drivable area and obstacles or delimiters of a drivable area in a scene based on the EM data.

19. The system of claim 19, wherein output from the module is used for producing at least one suggestion for steering a vehicle.
